(19) United States
(12) Patent Application Publication
(10) Pub. No.: US 2008/0166490 A1
(43) Pub. Date: Jul. 10, 2008

(54) CLOSED-LOOP BUBBLE ELIMINATION SYSTEM AND METHODS FOR APPLYING A CONFORMAL COATING MATERIAL TO A SUBSTRATE

(75) Inventors: Patrick Hogan, San Marcos, CA (US); Gareth De Sanctis, San Diego, CA (US)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 11/971,839

(22) Filed: Jan. 9, 2008

Related U.S. Application Data
(60) Provisional application No. 60/884,030, filed on Jan. 9, 2007.

(51) Int. Cl. B05D 1/02; B05B 7/00; B05B 7/16

(52) U.S. Cl. 427/422; 118/300; 427/421.1

(57) ABSTRACT

Systems and methods for applying a conformal coating material to a substrate, such as an electronic component or circuit board. The systems and methods rely on a pressure-regulated fluid circulation loop connecting an outlet of a pump with an inlet of a pump and an applicator that is connected in fluid communication with the fluid circulation loop. Amounts of the conformal coating material dispensed by the applicator, which are diverted from the fluid circulation loop, may be replenished by fresh amounts supplied from a non-pressurized reservoir, which are siphoned by the pump into the fluid circulation loop.

### CROSS-REFERENCE TO RELATED APPLICATIONS

This application claims the benefit of U.S. Provisional Application No. 60/884,030, filed Jan. 9, 2007, the disclosure of which is hereby incorporated by reference herein in its entirety.

### FIELD OF THE INVENTION

The present invention relates generally to conformal coating systems and, more particularly, to systems and methods for applying a conformal coating material to a substrate, such as a circuit board.

### BACKGROUND OF THE INVENTION

Conformal coating systems are used to apply dielectric coatings onto an electrical component, for example, a printed circuit board (“PCB”) or a device mounted thereon, to protect it from moisture, fungus, dust, corrosion, abrasion, and other environmental stresses. Common conformal coating materials include silicone, acrylic, polyurethane, epoxy synthetic resins and various polymers. When applied to a PCB, an insulative resin film of uniform thickness is formed as a solvent carrier evaporates or, as a solvent-free material is cured. A conformal coating can be applied using a dipping process or an automated applicator. However, more current applications require that the conformal coating be applied to selected areas of the PC board and the components thereon in order to preserve electrical and/or heat conduction properties on specific uncoated areas. Furthermore, different conformal coating materials may be required; and it is often desirable to apply the conformal coating materials in different patterns, for example, a straight bead, a bead that is continuously rotated in a curved or circular pattern, and/or a bead that is atomized.

Conformal coating materials dispensed by conventional conformal coating systems may be susceptible to the entrainment of gas bubbles, which may be retained after the conformal coating material is cured. Specifically, conformal coating materials are delivered to a conformal coating system with the assistance of a pressurized bulk container or pressure pot. Typically, shop air pressure or nitrogen is used to statically pressurize a head space of the reservoir containing the conformal coating material inside the pressure pot. The pressurization forces the conformal coating material out of the pressure pot. Unfortunately, a detrimental consequence of the pressurization is that some of the pressurized gas will be absorbed by the conformal coating material and form bubbles entrained in the conformal coating material that is ultimately delivered to the conformal coating system for application onto the PCB.

One conventional solution that has been partially successful in eliminating the entrainment of gas bubbles is to supply the conformal coating material sealed inside a flexible containment bag that is placed inside of the pressure pot. The flexible containment bag operates to isolate the conformal coating material from the gas pressure. However, flexible containment bags may be constructed from a material that is susceptible to chemical attack by some solvents found in certain conformal coating materials. This deficiency restricts the universal use of flexible containment bags in conformal coating systems.

Therefore, improved systems and methods for applying a conformal coating material are needed that are not susceptible to the entrainment of gas bubbles into the conformal coating material.

### SUMMARY OF THE INVENTION

In one embodiment, a system is provided for applying a conformal coating material to a substrate. The system includes a pump having a first inlet and an outlet. The pump is configured to pump the conformal coating material from the first inlet to the outlet. A fluid regulator has an inlet connected to the outlet of the pump and an outlet connected to the first inlet of the pump such that a fluid circulation loop is defined from the outlet of the pump through the fluid regulator to the first inlet of the pump. An applicator is connected in fluid communication with the fluid circulation loop to receive at least a portion of the conformal coating material. The applicator is configured to dispense amounts of the conformal coating material received from the fluid circulation loop onto the substrate.

In another embodiment, a system is provided for applying a conformal coating material to a substrate. The system includes a pump having a first inlet, a second inlet, and an outlet connected to the first inlet by a fluid circulation loop. The pump is configured to pump the conformal coating material from the first inlet and the second inlet through the fluid circulation loop to the outlet. An applicator is connected in fluid communication with the fluid circulation loop to receive at least a portion of the conformal coating material. The applicator is configured to dispense amounts of the conformal coating material received from the fluid circulation loop onto the substrate. A non-pressurized reservoir is configured to contain a bulk supply of the conformal coating material. The pump is configured to siphon the conformal coating material from the non-pressurized reservoir into the second inlet to replace the amounts of the conformal coating material dispensed by the applicator.

In another embodiment, a method is provided for applying conformal coating material to a substrate. The method includes circulating the conformal coating material in a fluid circulation loop connecting an outlet of a pump with a first inlet of a pump and regulating a pressure of the conformal coating material circulating in the fluid circulation loop between the outlet and first inlet of the pump. The method further includes diverting at least a portion of the conformal coating material from the fluid circulation loop to an applicator and dispensing amounts of the conformal coating material from the applicator onto the substrate.

### BRIEF DESCRIPTION OF THE DRAWING

The accompanying drawings, which are incorporated in and constitute a part of this specification, illustrate exemplary embodiments of the invention and, together with a general description of embodiments of the invention given above, and the detailed description given below, serve to explain the principles of the embodiments of the invention.

FIG. 1 is a schematic view of a conformal coating system in accordance with an embodiment of the invention.

FIG. 2 is a schematic view of a fluid supply for the conformal coating system of FIG. 1.

FIG. 3 is a schematic view similar to FIG. 2 of a fluid supply in accordance with an alternative embodiment of the invention.

### DETAILED DESCRIPTION

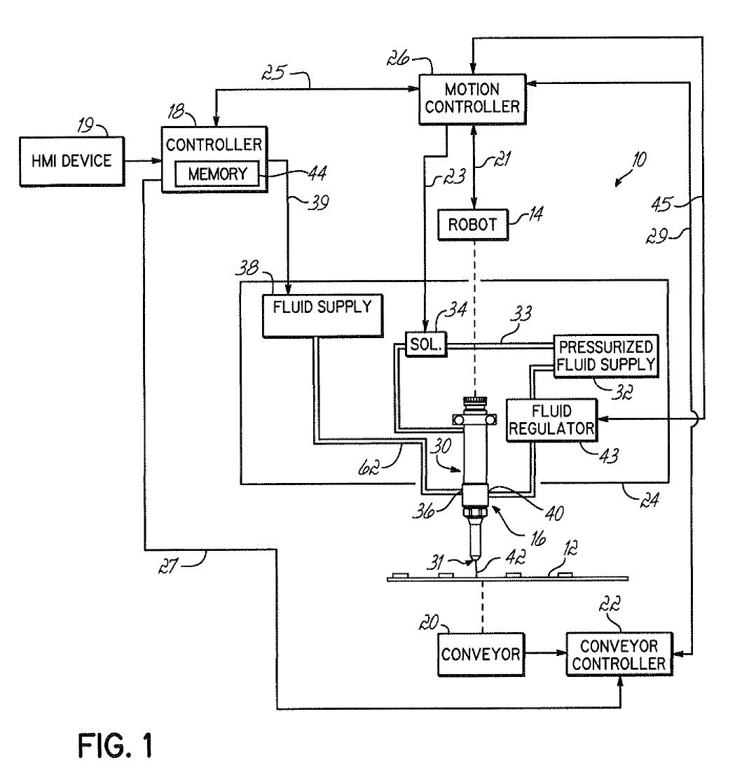

With reference to FIG. 1, a coating system, generally indicated by reference numeral 10, may be used to apply a conformal coating material to a series of substrates, such as the representative substrate 12 that is depicted to be a printed circuit board. The coating system 10 includes a multi-axis electro-mechanical positioner or robot 14 and a conformal coating applicator 16 coupled with the robot 14. For example, the applicator 16 may be suspended from the robot 14 above the substrates 12. In one embodiment, the robot 14 is adapted to move the applicator 16 in directions defined within an X-Y-Z Cartesian coordinate frame to supply three degrees of freedom. The robot 14 includes a drive coupled to independently controllable motors (not shown) in a known manner. The applicator 16 is manipulated by robot 14 relative to the substrate 12 for applying amounts of conformal coating material to selected areas of the substrate 12.

A programmable controller 18 coordinates the movements and actuations of the coating system 10. The programmable controller 18 may be a programmable logic controller (PLC), a microprocessor based controller, personal computer, or another conventional control device capable of carrying out the functions described herein as understood by a person having ordinary skill in the art. A human machine interface (HMI) device 19 is operatively connected to the programmable controller 18 in a known manner. The HMI device 19 may include input devices and controls, such as a keypad, pushbuttons, control knobs, a touch screen, etc., and output devices, such as displays and other visual indicators, that are used by an operator to control the operation of the programmable controller 18 and, thereby, control the operation of the coating system 10.

Substrates 12, for example, printed circuit boards with attached semiconductor die and other components, are supported in an operative relationship with the applicator 16 in a known manner and conformal coating material is applied from the applicator 16 onto selected areas on each substrate 12. Depending on the dispensing application, a series of substrates 12 may be coated in a batch mode. Alternatively, the substrates 12 may be continuously transported past the applicator 16 on an automatic conveyor 20. The automatic conveyor 20 has a conventional design and, furthermore, may have a width that can be adjusted to accommodate substrates 12 of different dimensions. The automatic conveyor 20, which may also include pneumatically operated lift and lock mechanisms (not shown), receives command signals from a conveyor controller 22.

An applicator controller 24, which is electrically coupled with the applicator 16, generates command signals that control the operation of the applicator 16. A motion controller 26 is electrically coupled by a communication link 21 with the robot 14. The conveyor controller 22 and motion controller 26 are also electrically coupled with programmable controller 18 over respective communication links 25, 27. The motion controller 26 is electrically coupled over a communication link 29 with the conveyor controller 22. A programmable control system for coating system 10 may be considered to include the programmable controller 18, the applicator controller 24, the motion controller 26, and the optional conveyor controller 22 as interconnected components that communicate with each other.

The motion controller 26 supplies command signals to the robot 14 over the communication link 21. The command signals are used by the robot 14 to control the position and/or velocity of the applicator 16. Generally, the robot 14 includes electric motors, such as servo motors or stepper motors, that drive the motion of the different motion axes of the robot 14.

Applicator 16 includes an applicator body 30 suspended from the robot 14, a nozzle 31 mounted to one end of the applicator body 30, and a flow control mechanism (not shown) disposed inside the applicator body 30. The flow control mechanism inside the applicator body 30 may include an air-actuated needle, an air piston, and a valve seat that cooperate to form a dispensing valve (not shown) that is operative to control a flow of conformal coating material dispensed from the applicator 16. A pressurized fluid supply 32 and a solenoid 34 cooperate to supply pressurized fluid in a known manner to regulate the actuation of the dispensing valve inside the applicator body 30. The solenoid 34 is electrically coupled by a communication link 23 with the motion controller 26. Specifically, upon receiving an appropriate commence from the motion controller 26, the solenoid 34 controls air pressure in a conduit 33 connecting the pressurized fluid supply 32 with the applicator 16 so as to move the air piston and, thereby, move the needle relative to the valve seat to provide an opened position for the dispensing valve in which conformal coating material is dispensed from the applicator 16 onto the substrate 12. The solenoid 34 may vent the air pressure acting on the air piston to permit the needle to return to a closed position in which the needle contacts the valve seat to discontinue the dispensing.

The coating system 10 includes a fluid supply 38 that is configured to supply conformal coating material to the applicator substantially free of entrained gas bubbles. The applicator 16 includes a liquid inlet 36 that is coupled in fluid communication with the fluid supply 38. The conformal coating material is supplied from the fluid supply 38 to the applicator 16 through the liquid inlet 36 for regulated dispensing out of a dispensing orifice (not shown) in the nozzle 3 1.

The applicator body 30 may optionally include another fluid inlet 40 coupled with pressurized fluid supply 32 and internal passageways (not shown) that direct the pressurized fluid to outlets in the vicinity of the dispensing orifice in nozzle 3 1, where the pressurized fluid is discharged to interact with and/or steer or atomize the stream 42 of conformal coating material that is dispensed from the applicator 16. A fluid regulator 43, which for receiving command signals over communication link 45 from motion controller 26, controls the flow of pressurized fluid from the pressurized fluid supply 32 to the optional fluid inlet 40. In an alternative embodiment, the fluid inlet 40 and internal passageways may be omitted from the applicator 16. A representative applicator similar to applicator 16 is described in U.S. Pat. No. 7,028,867, the disclosure of which is hereby incorporated by reference herein in its entirety.

The system 10 is operated as instructed by a library of operational cycles or sequences that are stored in a memory 44 associated with the programmable controller 18 and/or stored in other computers linked with programmable controller 18. The operational sequences are recalled and placed in a particular operational program, as desired, executing on the programmable controller 18. The operational sequences can be adjusted to accommodate different environmental conditions, different types of substrates 12, or different types of conformal coating material. During operation, the programmable controller 18 can transfer a stream of commands over communication link 25 to the motion controller 26. Alternatively, the programmable controller 18 can download an entire operational program over communication link 25 to the motion controller 26 at the motion controller 26.

The operator may use the HMI device 19 to enter parameters, such as the type of substrate 12, the fluid pressure, velocities and accelerations for movement of the applicator 16, the height of the applicator 16 above the substrate 12, etc. The entered parameters are stored in the memory 44 of programmable controller 18 for future use as data in an operational sequence. For each substrate 12, an operator may manually select a coating program that determines which specific components and areas of the substrate 12 are to be coated with conformal coating material. Alternatively, a reader may read a product identification (i.e., a bar code) from each substrate 12 as it enters the coating system 10 and match the read product identification with a coating program for the particular substrate 12. Typically, the conformal coating material is applied to only selected areas and/or components on the substrate 12.

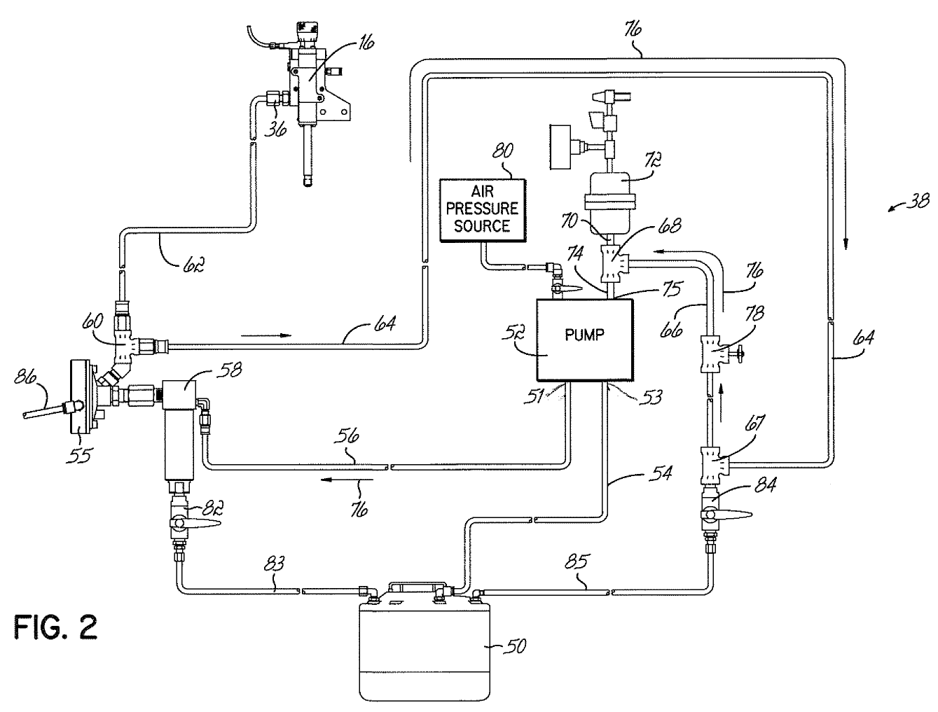

With reference to FIG. 2, the fluid supply 38 of the coating system 10 is a closed loop system that includes a non-pressurized reservoir 50 containing a volume of conformal coating material, a pump 52, a fluid regulator 55, and a filter 58 between the pump 52 and fluid regulator 55. The pump 52 has a first inlet 53 coupled by a conduit 54 with an outlet from the reservoir 50. The fluid regulator 55 has an inlet coupled with an outlet 51 of the pump 52 by a conduit 56. The filter 58 removes unwanted solid debris from the conformal coating material in the conduit 56. The fluid supply 38 further includes a tee fitting 60 having an inlet coupled with an outlet from the fluid regulator 55. A conduit 62 couples one outlet from the tee fitting 60 with an inlet to the applicator 16. Conduits 64, 66, as well as a tee fitting 67, couple another outlet from the tee fitting 60 with a tee fitting 68, which has one outlet coupled by a conduit 70 with an accumulator 72 and another outlet coupled by a conduit 74 with a second inlet 75 to the pump 52.

The conduits 56, 64, 66, 74 define a fluid circulation loop in which conformal coating material continuously circulates in a direction indicated generally by the single headed arrows labeled with reference numeral 76. If the applicator 16 is open, a portion of the conformal coating material is diverted from the fluid circulation loop and, after passing through the fluid regulator 55, flows in conduit 62 toward the applicator 16. The remainder of the conformal coating material continues to circulate in the fluid circulation loop. If the applicator 16 is closed, the conformal coating material continues circulates through the fluid circulation loop and the conformal coating material residing in conduit 62 is static. A circulation valve 78, which is disposed in conduit 66, controls the rate of circulation through the fluid circulation loop.

Pump 52, when operating, maintains continuous and steady circulation of the conformal coating material in the fluid circulation loop of the closed loop system. Pump 52 is further equipped to siphon fresh amounts of the conformal coating material from the non-pressurized reservoir 50 to replenish the constant volume in the fluid circulation loop as conformal coating material is diverted from the fluid circulation loop to the applicator 16. The diversion of the conformal coating material through conduit 62 to the applicator 16 automatically occurs as amounts of the material are dispensed from the applicator 16.

Pump 52 may comprise any type of positive displacement pump capable of siphoning the conformal coating material from the non-pressurized reservoir 50, which is vented to ambient pressure. A positive displacement pump operates by trapping a fixed volume of the conformal coating material and then displacing the trapped volume into the conduit 56. In a representative embodiment, pump 52 may be a diaphragm pump, which is a positive displacement pump that uses a combination of the reciprocating action of a flexible diaphragm and suitable non-return check valves that prevent reverse flow to pump the conformal coating material in the fluid circulation loop. The diaphragm of the diaphragm pump is sealed with one side wetted by the conformal coating material residing in a pump chamber and the other side wetted by pressurized air received from an air pressure source 80 so that the pressurized air and conformal coating material are isolated. The air pressure flexes the diaphragm, which causes the volume of the pump chamber to increase and decrease and forces the conformal coating material out of the outlet from the pump 52. In one specific embodiment, the diaphragm pump constituting pump 52 may be a one-to-one pump in which the outlet pressure of the conformal coating material is approximately equal to the air pressure supplied from air pressure source 80.

The use of pump 52 eliminates the need for a gas pressure head inside the non-pressurized reservoir 50. As a result, there is no interface between the conformal coating material contained inside the non-pressurized reservoir 50 and a pressurized gas, as in conventional conformal coating systems. This eliminates the occurrence of bubbles in the conformal coating material dispensed from the applicator 16, which plagues conventional conformal coating systems. By suctioning material directly from the ventilated, non-pressurized reservoir 50, the conformal coating material is not exposed to a pressurized gas. Thus, the conformal coating system provides for a steady fluid pressure to the applicator 16 while not introducing gas into the conformal coating material.

During normal operation of the fluid supply 38, the pump 52 is constantly stroking, which promotes a continuous flow of the conformal coating material fluid through the fluid circulation loop. This continuous flow condition minimizes the opportunity for the pump 52 to stall. In one embodiment, the flow rate of the pump 52, which is equal to the product of the volume per stroke and the stroke rate, may be adjusted to be a factor of three-times or four-times greater than the flow rate of conformal coating material dispensed out of the applicator 16.

The fluid regulator 55 controls the fluid pressure of the conformal coating material in the fluid circulation loop, as well as the fluid pressure at the applicator 16. In one embodiment, the fluid regulator 55 may be an A/F regulator that receives air pressure over an air line 86, which in turn controls the fluid pressure at a location upstream of the tee fitting 60. The air pressure in air line 86 is regulated by a valve that, in one embodiment, is manually adjusted by the operator to a fixed value.

The accumulator 72, which is provided in the fluid circulation loop on the inlet side of the pump 52, operates to stabilize the pressure of the conformal coating material circulating in the fluid circulation loop. The accumulator 72 is effectively an energy storage device that serves as a pressurized storage reservoir for the non-compressible conformal coating material. A negative pressure is maintained on the conformal coating material stored by the accumulator 72 and, hence, on the conformal coating material in conduits 70, 74 between the accumulator 72 and the second inlet 75 of the pump 52. The pressure stabilization afforded by the accumulator 72 on the inlet side of the pump 52 operates to minimize the momentary drop in the flow of the conformal coating material to the outlet 51 that may occur when the pump 52 shifts. The improved control over the flow to the outlet 51 of pump 52 in turn smoothes any pressure pulsations in coating material pressure at the applicator 16. If not minimized by the accumulator 72, the pressure pulsations may lead to a defect in the film pattern applied to the substrate 12.

The accumulator 72 includes a chamber 68a that is filled by a volume of the conformal coating material, a chamber 68b that is kept at a sub-atmospheric pressure, and a diaphragm 71 that physically separates the chambers 68a, 68b. The diaphragm 71 isolates the conformal coating material in chamber 68a from the evacuated environment inside chamber 68b. A Venturi tube 73, which relies on the flow of a pressurized gas to suction gases from chamber 68b, is used to establish the sub-atmospheric pressure in chamber 68b. A manual valve 75 is opened to evacuate chamber 68b with the operation of the Venturi tube and closed to isolate chamber 68b from the Venturi tube. A pressure gauge 77, which is in communication with chamber 68b, indicates the partial vacuum level inside chamber 68b to an operator.

The fluid circulation loop includes a drain valve 82 located near the filter 58 and another drain valve 84 located at the juncture between conduits 64 and 66. The drain valves 82, 84, which are coupled by respective conduits 83, 85 with inlets to the non-pressurized reservoir 50, are used to prepare the fluid supply 38 for use. When the operation of the fluid supply 38 is begun, the conduits 56, 62, 64, 66, 70, 74 are initially filled by air. When the pump 52 is started to initiate the forced flow of conformal coating material in the fluid circulation loop, the drain valve 82 located near the filter 58 is opened. The conformal coating material and air flowing in conduit 56 exits through a drain port in the drain valve 82 and is returned through conduit 83 to the non-pressurized reservoir 50. The arriving air escapes through the vent of the non-pressurized reservoir 50 and the arriving conformal coating material is collected.

Drain valve 82 is closed and, with circulation valve 78 closed, drain valve 84 is opened so that conformal coating material and air flowing in conduit 56 in the fluid circulation loop exits through a drain port in the drain valve 82. Because circulation valve 78 is closed, the conformal coating material and air is forced to flow through conduit 85 to the non-pressurized reservoir 50. The arriving air is vented from the non-pressurized reservoir 50 and the arriving conformal coating material is collected. Drain valve 84 is closed and the circulation valve 78 is opened to establish the fluid circulation loop to pump 52. Applicator 16 is opened to displace air in conduit 62 with conformal coating material and eject the air through the dispensing orifice in the nozzle 3 1. After the air is displaced, the applicator 16 of the coating system 10 is ready for use in applying conformal coating material to one or more substrates 12.

In use and with reference to FIGS. 1 and 2, the programmable controller 18 obtains a coating program for the substrate 12 from a disk or a computer integrated manufacturing controller (not shown). The coating program determines which components and/or areas of the substrate 12 are to be coated with conformal coating material, which is usually applied in strips. For example, possibly twenty-five separate components or areas of a substrate 12 may be coated with strips of the conformal coating material. In accordance with the coating program, the conformal coating material is selectively applied on these desired regions of the substrate 12 while avoiding the deposit of conformal coating material on regions to be deliberately left uncoated.

As will be appreciated, a library of operational cycles or sequences can be accumulated and stored in the programmable controller 18 and/or other computers. Further, those operational sequences can be recalled upon demand and placed in a particular operational program. The operation sequences may be further tuned to accommodate different environmental conditions, different substrates, or different types of conformal coating material. The programmable controller 18 retrieves all or a portion of an operational sequence from the memory 44 of programmable controller 18 and, in turn, communicates control signals to the motion controller 26 over communication link 25 representing the operational sequence.

The motion controller 26, in turn, sends command signals to the robot 14 over communication link 21 that instruct the robot 14 to move the applicator 16 with specified velocities to desired locations with respect to the substrate 12. The motion controller 26 controls the movements of the robot 14 to move the applicator 16 in a plane (e.g., X and Y directions) across the substrate 12, opening and closing the dispensing valve in the applicator 16 as necessary during this movement to apply the conformal coating material to the desired components and areas of the substrate 12.

Specifically, at any particular location above substrate 12, the motion controller 26 also provides a command signal to the solenoid 34 to cause it to change state to open the dispensing valve, which results in the discharge of conformal coating material from nozzle 31 of applicator 16. Concurrently, the motion controller 26 provides command signals to the robot 14 to initiate motion of applicator 16 relative to the substrate 12. The stream 42 of conformal coating material may be optionally manipulated by an assist fluid, such as air, that affects the shaping of the stream 42 discharged from the applicator 16. After a predetermined time lapses, the motion controller 26 subsequently changes the state of the valve command signal to return the solenoid 34 back to its original state. This action closes the dispensing valve to discontinue the discharge of conformal coating material from the nozzle 31 of the applicator 16. The motion controller 26 may cause the dispensing valve of the applicator 16 to open and close the dispensing valve multiple times (e.g., twenty-five times) during the extent of the coating program so that conformal coating material is applied to multiple components and areas of the substrate 12.

The conformal coating material that is not diverted through conduit 62 to the applicator 16 continues to circulate in the fluid circulation loop. As conformal coating material is dispensed from the applicator 16, the pump 52 siphons fresh conformal coating material from the non-pressurized reservoir 50. This replenishment compensates for the amounts dispensed from the applicator 16, which are removed from the conformal coating material circulating in the fluid circulation loop.

During the coating program or in preparation for the execution of the coating program, the air pressure supplied to the fluid regulator 55 may be manually set by the operator. The air pressure determines a fluid pressure for the conformal coating material flowing in the fluid circulation loop and a fluid pressure of the conformal coating material at the applicator 16. The selected value of fluid pressure may depend on the desired flow rate of the conformal coating material from the applicator 16. The flow rate for the conformal coating material is influenced, among other factors, by the fluid pressure, the diameter of the discharge orifice in the nozzle 3 1, and the nominal viscosity of the conformal coating material.

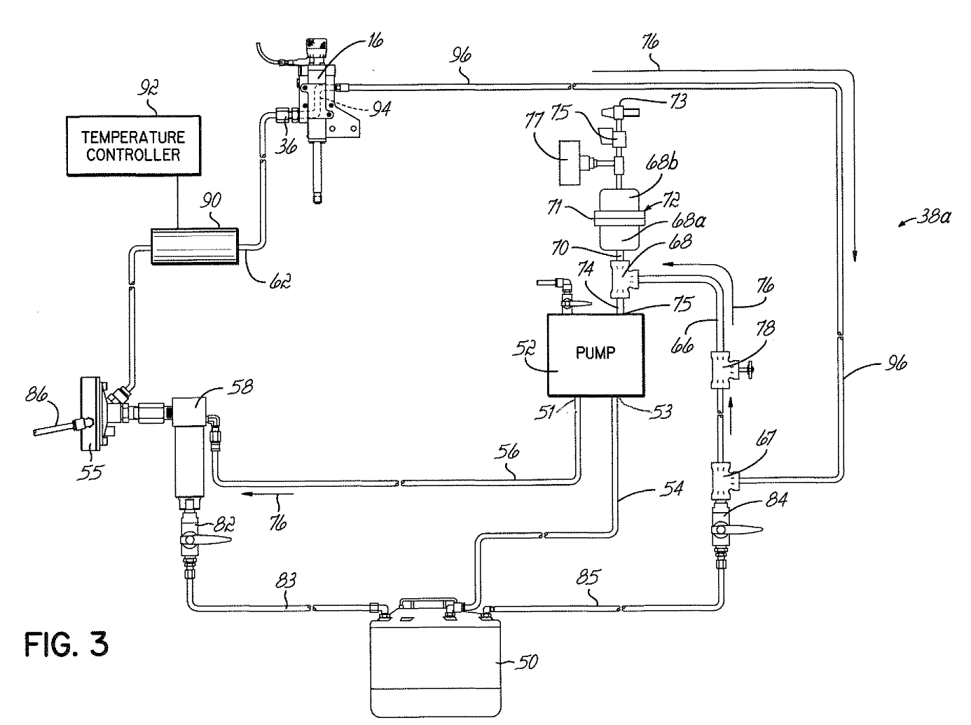

With reference to FIG. 3 in which like reference numerals refer to like features in FIG. 2 and in accordance with an alternative embodiment of the invention, a fluid supply, generally indicated by reference numeral 38a, is similar to the fluid supply 38 (FIGS. 1 and 2) but further includes a heater 90 that is electrically coupled with the heater control circuitry of a temperature controller 92. Control logic circuitry for the temperature controller 92 is electrically coupled with the programmable controller 18. The construction and operation of the heater 90 and temperature controller 92 are understood by a person having ordinary skill in the art.

The applicator 16 includes a passageway 94 that has an inlet that receives conformal coating material from conduit 62 and an outlet that is coupled by a conduit 96 with the inlet to tee fitting 67. As a result, the entire flow of conformal coating material in the fluid circulation loop is directed through conduit 62 to the passageway 94 in applicator 16. The conduits 56, 62, 96, as well as the passageway 94, define a fluid circulation loop in which conformal coating material continuously circulates in direction 76. The amounts of conformal coating material dispensed by the applicator 16 are diverted from the passageway 94 by the operation of the flow control mechanism inside the applicator body 30 and directed to the dispensing orifice of the nozzle 3 1.

The heater 90, which is located between the fluid regulator 55 and the applicator 16, is operative to heat the conformal coating material flowing in conduit 62 of the closed circulation path before the material is applied from the applicator 16 to the substrate 12. The temperature of the conformal coating material is elevated while in the fluid circulation loop by heat energy transferred from the heater 90 to the conformal coating material in the conduit 62. A temperature sensor (not shown) is used to detect a temperature of the conformal coating material flowing inside the fluid circulation loop. Readings from the temperature sensor are communicated as output signals to the programmable controller 18, which relies on these readings as feedback for regulating the operation of the heater 90 with commands communicated to the temperature controller 92.

In one representative embodiment, the heater 90 may consist of a metal fluid passage body containing a flow passageway for the conformal coating material. The metal body is drilled with ports that are occupied by electrically operated, resistance-type cartridge heaters. The heat transferred from the heater 90 to the conformal coating material in the flow passageway is effective to reduce the viscosity of the coating material flowing in the fluid circulation loop.

While the invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

What is claimed is:

1. A system for applying a conformal coating material to a substrate, the system comprising:
a pump having a first inlet and an outlet, said pump configured to pump the conformal coating material from said first inlet to said outlet;
a fluid regulator having an inlet connected to said outlet of the pump and an outlet connected to said first inlet of said pump such that a fluid circulation loop is defined from said outlet of said pump through said fluid regulator to said first inlet of said pump; and
an applicator connected in fluid communication with the fluid circulation loop to receive at least a portion of the conformal coating material, said applicator configured to dispense amounts of the conformal coating material received from the fluid circulation loop onto the substrate.

2. The system of claim 1 further comprising:
an accumulator connected to the fluid circulation loop between said fluid regulator and said first inlet of said pump.

3. The system of claim 1 further comprising:
a circulation valve provided in the fluid circulation loop, said circulation valve configured to control the rate of circulation of the conformal coating material through the fluid circulation loop.

4. The system of claim 3 wherein said circulation valve is located in the fluid circulation loop between said fluid regulator and said first inlet to said pump.

5. The system of claim 1 wherein pump is a positive displacement pump configured to pump successive fixed volumes of the conformal coating material to said outlet of said pump.

6. The system of claim 5 further comprising:
an accumulator connected to the fluid circulation loop at a location between said fluid regulator and said first inlet of said positive displacement pump.

7. The system of claim 1 wherein said pump includes a second inlet, and further comprising:
a non-pressurized reservoir configured to contain a bulk supply of the conformal coating material, said pump configured to siphon the conformal coating material from said non-pressurized reservoir into said second inlet to replace the amounts of the conformal coating material dispensed by said applicator.

8. The system of claim 1 further comprising:
a heater configured to regulate the temperature of the conformal coating material dispensed by the applicator.

9. The system of claim 8 wherein said applicator includes a body and a passageway extending through said body, said outlet of said fluid regulator connected with said first inlet of said pump through said passageway in said body such that all of the conformal coating material in the fluid circulation loop flows through said passageway in said body.

10. The system of claim 9 wherein said heater is located in said fluid circulation loop between said outlet of said fluid regulator and said passageway in said body of said applicator.

11. The system of claim 1 further comprising:
a least one drain valve in the fluid circulation loop.

12. The system of claim 1 further comprising:
a filter in the fluid circulation loop between said outlet of said pump and said inlet of said fluid regulator.

13. The system of claim 1 wherein said applicator is connected in fluid communication with the fluid circulation loop between said outlet of said fluid regulator and said first inlet of said pump.

14. A system for applying a conformal coating material to a substrate, the system comprising:
a pump having a first inlet, a second inlet, and an outlet connected to said first inlet by a fluid circulation loop, said pump configured to pump the conformal coating material from said first inlet and said second inlet through the circulation loop to said outlet;
an applicator connected in fluid communication with the fluid circulation loop to receive at least a portion of the conformal coating material, said applicator configured to dispense amounts of the conformal coating material received from the fluid circulation loop onto the substrate; and
a non-pressurized reservoir configured to contain a bulk supply of the conformal coating material, said pump configured to siphon the conformal coating material from said non-pressurized reservoir into said second inlet to replace the amounts of the conformal coating material dispensed by said applicator.

15. The system of claim 14 wherein pump is a positive displacement pump configured to pump successive fixed volumes of the conformal coating material to said outlet of said pump.

16. The system of claim 15 further comprising:
an accumulator connected to the fluid circulation loop at a location between said fluid regulator and said first inlet of said positive displacement pump.

17. A method of applying a conformal coating material to a substrate, the method comprising:
circulating the conformal coating material in a fluid circulation loop connecting an outlet of a pump with a first inlet of a pump;
regulating a pressure of the conformal coating material circulating in the fluid circulation loop;
diverting at least a portion of the conformal coating material from the fluid circulation loop to an applicator; and
dispensing amounts of the conformal coating material from the applicator onto the substrate.

18. The method of claim 17 further comprising:
moving the applicator relative to the substrate while the amounts of the conformal coating material are dispensed.

19. The method of claim 17 further comprising:
regulating the flow of the conformal coating material to the applicator and in the fluid circulation loop.

20. The method of claim 17 wherein circulating the conformal coating material in the fluid circulation loop further comprises:
pumping the conformal coating material from the first inlet of the pump to the outlet of the pump.

21. The method of claim 20 wherein pumping the conformal coating material further comprises:
pumping a plurality of fixed volumes of the conformal coating material successively to the outlet of the pump.

22. The method of claim 20 further comprising:
storing a volume of the conformal coating material under a negative pressure in an accumulator coupled with the fluid circulation loop; and
transferring a portion of the volume of the conformal coating material stored in the accumulator to the fluid circulation loop in response to a flow rate drop in the fluid circulation loop resulting from the pumping.

23. The method of claim 17 further comprising:
heating the conformal coating material circulating in the fluid circulation loop.

24. The method of claim 17 further comprising:
siphoning additional conformal coating material from a non-pressurized reservoir into a second inlet of the pump to replace the amounts of the conformal coating material diverted from the fluid circulation loop to the applicator.

25. The method of claim 17 further comprising:
storing a volume of the conformal coating material under a negative pressure in an accumulator coupled with the fluid circulation loop; and
transferring a portion of the volume of the conformal coating material stored in the accumulator to the fluid circulation loop in response to a flow rate drop in the fluid circulation loop.
